(19) United States
(12) Patent Application Publication
(10) Pub. No.: US 2025/0257235 A1
(43) Pub. Date: Aug. 14, 2025

(54) INK AND METHOD FOR PRODUCING INK

(71) Applicant: HONDA MOTOR CO., LTD., Tokyo (JP)

(72) Inventors: Shinya SATO, Saitama (JP); Naoki KUSHITANI, Saitama (JP); Takanori IGARASHI, Saitama (JP)

(21) Appl. No.: 19/047,646

(22) Filed: Feb. 7, 2025

(30) Foreign Application Priority Data
Feb. 13, 2024 (JP) 2024-019267

(51) Int. Cl. C09D 11/52; H01M 8/1004

(52) U.S. Cl. CPC C09D 11/52; H01M 8/1004

(57) ABSTRACT

An ink production method is a method for producing an ink for use in the formation of a membrane electrode assembly of a fuel cell, the method includes: a generation step of mixing ionomer and solvent to generate an ionomer solution having a concentration of solid content of 7.5% by mass or more and an alcohol ratio in the solvent of 85% by mass or more; and a shearing treatment step of applying a shear force to the ionomer solution generated in the generation step.

This application is based on and claims the benefit of priority from Japanese Patent Application No. 2024-019267, filed on 13 Feb. 2024, the content of which is incorporated herein by reference.

### BACKGROUND OF THE INVENTION

### Field of the Invention

The present invention relates to an ink which can be used in the formation of a membrane electrode assembly of a fuel cell, and a method for producing ink.

### Related Art

In recent years, fuel cells which generate electricity by electrochemically reacting hydrogen and oxygen have been receiving attention as a novel power source for automobiles, etc. Fuel cells are said to be preferable in the point of having high power generation efficiency due to obtaining electricity directly from an electrochemical reaction. In addition, fuel cells are said to be preferable from the point of environmental impact due to only generating water during power generation.

The fuel cell includes a membrane electrode assembly configured by sandwiching the electrolyte membrane between a pair of catalyst layers. The catalyst layers of the membrane electrode assembly, for example, are formed by applying ink containing ionomer and solvent as an ion conductive member to the surface of the electrolyte membrane, and then drying.

As a document describing technology related to an ink for the preparation of a membrane electrode assembly, there is Japanese Unexamined Patent Application, Publication No. 2014-192070, for example. Japanese Unexamined Patent Application, Publication No. 2014-192070 describes an ink production method which prepares an ionomer solution by mixing ionomer and solvent, concentrating the prepared ionomer solution and adjusting the SP value of the solvent component to 12.3 or less to produce an ink in the gel form.
Patent Document 1: Japanese Unexamined Patent Application, Publication No. 2014-192070

### SUMMARY OF THE INVENTION

However, with the ink production method of Japanese Unexamined Patent Application, Publication No. 2014-192070, it is necessary to concentrate the solution made by mixing ionomer and solvent by heating. In addition, by employing alcohols such as the commonly used ethanol and 1-propanol, and water, a relatively great amount of time and energy becomes necessary in lowering the SP value of solvent to 12.3 or less, and the scope of material types which can be used narrows.

The present invention has an object of providing an easily producible ink which can be thickened by applying a constant shear force thereto, and a method for producing the ink.

An ink according to a first aspect of the present invention is an ink for use in formation of a membrane electrode assembly of a fuel cell, the ink including an ionomer; and a solvent having an alcohol ratio in solvent of 85% by mass or more, in which the ink has a concentration of a solid content of 7.5% by mass or more.

According to a second aspect of the present invention, in the ink as described in the first aspect, 74% by mass or more of the alcohol contained in the solvent is 1-propanol.

According to a third aspect of the present invention, in the ink as described in the first or second aspect, a solubility parameter of the solvent is 13 to 15.

An ink production method according to a fourth aspect of the present invention a method for producing an ink for use in formation of a membrane electrode assembly of a fuel cell, the method including: a generation step of mixing an ionomer and a solvent to generate an ionomer solution having a concentration of solid content of 7.5% by mass or more, and having an alcohol ratio in the solvent of 85% by mass or more; and a shearing treatment step of applying a shear force to the ionomer solution generated in the generation step.

According to a fifth aspect of the present invention, in the method for producing ink as described in the fourth aspect, 74% by mass or more of alcohol contained in the solvent is 1-propanol.

According to a sixth aspect of the present invention, in the method for producing ink as described in the fourth or fifth aspect, a solubility parameter of the solvent is adjusted to 13 to 15 in the generation step.

According to the present invention, it is possible to provide an easily producible ink which can be thickened by applying a constant shear force thereto, and a method for producing the ink.

### BRIEF DESCRIPTION OF THE DRAWINGS

FIG. 1 is a cross-sectional view showing a membrane electrode assembly of a fuel cell produced using an ink according to an embodiment of the present invention;

FIG. 2 is a flowchart showing a process of a method for producing the ink according to an embodiment of the present invention;

FIG. 3 is a chart showing a relationship between concentration of solid content in the ink and alcohol ratio in a solvent, with the viscosity of the ink; and

FIG. 4 is a graph showing a relationship between the viscosity of the ink and the shearing velocity.

### DETAILED DESCRIPTION OF THE INVENTION

Hereinafter, embodiments of the present invention will be described while referencing the drawings. However, the embodiments shown below are exemplifying the present invention, and the present invention is not to be limited to the following embodiments.

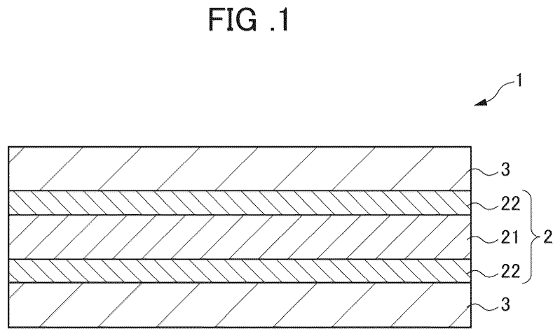

The ink according to the present embodiment can be used in the preparation of a fuel cell which generates electricity by reacting hydrogen and oxygen. First, a fuel cell 1 produced using the ink according to the present embodiment will be described while referencing FIG. 1.

### (Fuel Cell)

The fuel cell 1 is a solid polymer fuel cell which mainly includes a membrane electrode assembly 2, and gas diffusion layers 3. The solid polymer fuel cell has advantages in having low operating temperature, short startup time, and being compactly configurable, and thus are being utilized in fields such as the drive power source for automobiles.

The membrane electrode assembly 2 has an electrolyte membrane 21, and a pair of catalyst layers 22 arranged to sandwich and oppose the electrolyte membrane 21. The ink of the present embodiment can be used in the formation of the membrane electrode assembly 2.

The electrolyte membrane 21 is a proton conductive membrane in which a polymer belonging to cation exchange resins, and having proton conductivity is formed in a film form. As the cation exchange resin, for example, a sulfonated substance of a vinyl polymer such as polystyrene sulfonate; polymers to which a sulfonate group or phosphate group have been introduced to a heat resistant polymer such as perfluoroalkyl sulfonate polymer, perfluoroalkyl carboxylate polymer, polybenzimidazole, and polyether ether ketone; polymers with a main component of polyphenylene obtained by polymerizing an aromatic compound consisting of phenylene chains, and made by introducing a sulfonate group thereto, etc. can be exemplified.

The catalyst layer 22 is configured to include an electrode catalyst, and an ionomer which is a polymer electrolyte. Among the pair of catalyst layers 22, one functions as the anode of the fuel cell 1, and the other one functions as the cathode. It should be noted that the details of the ionomer will be described later.

The catalyst layer 22 can be prepared by coating a catalyst ink made by adding the electrode catalyst to the ink of the present embodiment onto a surface of the electrolyte membrane 21. The method of applying the catalyst ink is not particularly limited, and can use various application methods. As the application method, for example, bar coater application, knife coater application, doctor blade method, screen printing, spray application, etc. can be exemplified. As a coating method for preparing the catalyst layer 22 using the catalyst ink according to the present embodiment, it is preferable to use a die coat method which coats the substrate while extruding the catalyst ink from a slot die.

The electrode catalyst contained in the catalyst layer 22 is configured to include catalytic metal particles, and a conductive carrier which supports these catalytic metal particles.

The catalytic metal particles are not particularly limited so long as having catalyst activity; however, platinum and platinum alloys can be exemplified thereas. If using a platinum alloy, it is possible to impart stability and activity to the electrode catalyst. As the platinum alloy, it is preferably an alloy of platinum with at least one metal selected from the group consisting of platinum group metals other than platinum (ruthenium, rhodium, palladium, osmium, iridium), cobalt, iron, titanium, gold, silver, chromium, manganese, molybdenum, tungsten, aluminum, silicon, rhenium, zinc, and tin, and an intermetallic compound with a metal alloyed with platinum may be contained in this platinum alloy.

As the conductive carrier, it is possible to use carbon black, graphite, carbon fiber, activated carbon, etc. and their crushed products, carbon nanofibers, carbon nanotubes, and carbon compounds such as carbon nitride, carbon sulfide and carbon phosphide. The conductive carrier is not particularly limited so long as possessing electrical conductivity and moderate corrosion resistance; however, it is desirable to have sufficient specific surface area for high dispersion of catalytic metal particles, and to have sufficient electron conductivity.

The electrode catalyst which is the conductive carrier on which the catalytic metal particles are supported may use a prepared product, or may be a commercially available product. In the case of preparing the electrode catalyst, the preparation method thereof is not particularly limited, and a conventional, known method can be used. As conventional, known preparation methods of the electrode catalyst, for example, a method such that adds a solution or suspension of a platinum compound to a carrier powder, evaporative drying, followed by insolubilizing with acid or alkali, then reduction treating to activate the supported component can be exemplified.

It should be noted that the catalyst layer 22 of the present embodiment is formed by coating the catalyst ink made by adding the electrode catalyst to the ink onto the surface of the electrolyte membrane 21; however, it may be formed by coating the catalyst ink onto the gas diffusion layer 3. It should be noted that the mass ratio of ionomer relative to the electrode catalyst contained the catalyst ink for forming the catalyst layer 22 (mass of ionomer/electrode catalyst) is preferably 0.3 to 1.0. If the mass ratio of ionomer relative to the electrode catalyst is outside of the above-mentioned range, since a three-phase interface is hardly formed in the catalyst layer 22 thus formed, there is a tendency for the fuel cell performance to decline.

The gas diffusion layer 3 is configured by a porous sheet-shaped member. The sheet-shaped member, for example, may be nickel foam, carbon cloth, or the like. The gas diffusion layer 3 is arranged on a surface of the catalyst layer 22 on the opposite side to the electrolyte membrane 21.

### (Ink)

Next, the ink of the present embodiment will be described. The ink is a liquid mixture containing ionomer and solvent. The ink has a property of being a liquid in a state in which shear force is not being applied thereto, and increasing in viscosity and entering a state in which the liquidity is significantly impaired, i.e. becoming gel form, by applying a constant shear force thereto. It should be noted that the ink preferably has a property of lowering in viscosity and returning from gel form to liquid, when left for a predetermined time after changing from liquid to gel form by applying shear force.

The ionomer is used in the electrode reaction of the catalyst layer 22, and conducts the ions generated. As the ionomer, for example, a polymer including an ion-exchange group, which is a fluorine-based polymer in which at least part of the polymer skeleton is fluorinated, or a hydrocarbon-based polymer which is free of fluorine in the polymer skeleton, can be exemplified. As the ionomer, ionomers of a fluoride-system which is a fluorine-based polymer are preferable. In addition, the type of this ion-exchange group is not particularly limited, and can be arbitrarily selected according to the application. As the ion-exchange group, for example, sulfonic acid, carboxylic acid, phosphonic acid, etc. can be exemplified.

The solvent is a medium which causes the catalyst electrode and the ionomer to disperse, is configured to include at least an alcohol, and is preferably a mixed solvent of water and alcohol. The solvent contains 85% by mass or more of alcohol. In other words, the solvent has an alcohol ratio of 85% by mass or more.

As the alcohol, for example, at least one type selected from lower alcohols such as methanol, ethanol, 1-propanol, and 1-butanol, or a liquid mixture of two or more types thereof can be exemplified. The solvent preferably contains 1-propanol. The 1-propanol in the solvent is preferably 74% by mass of the alcohol contained in the solvent. The solvent in the present embodiment is a mixed solvent of water, ethanol and 1-propanol, for example. In addition, as organic solvents other than alcohols, the solvent may contain ketones such as acetone, diols such as ethylene glycol, and the like.

The solubility parameter (SP value) of the solvent is preferably 13.0 to 15.0, and is more preferably 13.5 to 14.5. By adjusting the SP value to within the range of 13.0 to 15.0, the dispersibility of ionomer is further promoted.

The ink has a concentration of solid content relative to the total amount thereof of 7.5% by mass or more. The ink more preferably has a concentration of solid content relative to the total amount thereof of 7.5% by mass or more and 17.0% by mass or less. The solid content of the ink in the present disclosure is the ionomer contained in the ink. In addition, the concentration of solid content in the present disclosure refers to a mass percent concentration of a total mass of the ionomer relative to the total mass of the ink.

The concentration of solid content, for example, can be specified by heating the ink to evaporate the solvent, and calculating the remaining amount after heating relative to the mass of ink prior to heating. The concentration of solid content, for example, may be measured using a moisture meter (MOC63u, manufactured by Shimadzu Corp.).

It should be noted that the ink of the present embodiment may further be used in the formation of the catalyst layer 22 by adding the electrode catalyst, and may be used in the formation of the electrolyte membrane 21 without adding the electrode catalyst.

The ink of the present embodiment established with the above such configuration has a property of being liquid in the normal state in which a shear force has not been applied thereto, and thickening by applying a constant shear force thereto. Coating to the electrolyte membrane 21, etc. during production of the membrane electrode assembly 2 thereby becomes easy. For example, in the case of preparing the membrane electrode assembly 2 by coating different types of coating materials, since the shear force is applied to the ink and thus becomes gel form upon coating the ink to the surface of the coating target using a slot die or the like, it is possible to prevent coating materials from mixing in the case of coating different types of coating materials thereon. In addition, the ink of the present embodiment has a concentration of solid content of 7.58 by mass or more, and has a high alcohol ratio in this solvent of 85% by mass or more; therefore, it can be produced easily without necessitating concentrating and heating during production as described later.

### (Method for Producing Ink)

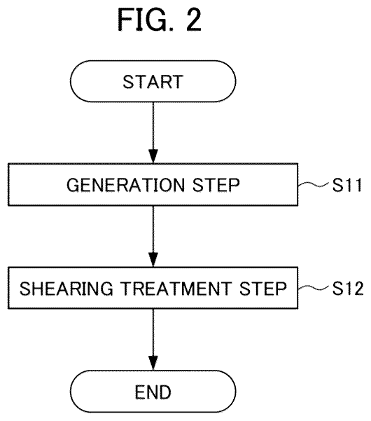

Next, a method for producing ink will be described while referencing FIG. 2. FIG. 2 is a flowchart for describing a method for producing the according to the present embodiment.

As shown in FIG. 2, the method for producing the ink according to the present embodiment includes a generation step S11, and a shearing treatment step S12.

In the generation step S11, the ionomer solution is generated by mixing the ionomer, water, and an alcohol such as 1-propanol as the solvent. In the generation step S11, the added amounts of ionomer, catalyst particles and solvent are adjusted so that the concentration of solid content relative to the total amount of the ionomer solution becomes 7.5% by mass or more, and the alcohol ratio in the solvent becomes 85% by mass or more.

The generation step S11 may include a dispersion generation step of generating an ionomer dispersion, and a dilution step of diluting the ionomer dispersion generated in the dispersion generation step, for example. In the dispersion generation step, for example, an ionomer dispersion containing water and ionomer, or an ionomer dispersion containing, water, ionomer and alcohol is generated. In the dilution step, for example, the ionomer dispersion generated in the dispersion generation step is diluted while adding an alcohol such as 1-propanol, or the like to raise the alcohol concentration in the solution, whereby the alcohol ratio and concentration of solid content are adjusted. In the present embodiment, concentrating and heating of the solvent are unnecessary. It should be noted that the SP value of the ionomer solution is adjusted to about 14.0.

In the shearing treatment step S12, shearing treatment of applying a shear force to the ionomer solution generated in the generation step S11 is performed. More specifically, in the present embodiment, shear force is applied to the ionomer solution by agitating the ionomer solution using an agitation device having a disper or the like. The rotation speed of the disper in the shearing treatment is preferably 4000 rpm or more and 6000 rpm or less, and the agitation time is preferably 20 minutes or longer.

It should be noted that, in the case of using the prepared ink in the formation of the catalyst layer 22, it is possible to adjust the viscosity of the ink by mixing the catalyst electrode after the shearing treatment step S12. By establishing the ink in gel form, it is possible to prevent mixing between inks upon doing a simultaneous multi-layer coating, for example.

According to the method for producing the ink according to the present embodiment established in the above such configuration, an ink having a property of being a liquid in a normal state in which a shear force is not being applied thereto, and thickening by applying a constant shear force thereto, can be produced easily without concentrating or heating of the solvent.

Preferred embodiments of the present invention have been described above. However, the present invention is not to be limited to the above embodiments, and modifications where appropriate are possible.

Next, the present invention will be described in further detail based on examples; however, the present invention is not to be limited thereto.

### EXAMPLES

### Example 1

An ink of Example 1 was prepared as follows. First, an aqueous dispersion of ionomer (Nafion, manufactured by Dupont) was placed in a container. Next, an ionomer solution was generated by diluting and mixing the aqueous dispersion of ionomer by adding ethanol and 1-propanol as alcohols to the container. At this time, the concentration of solid content relative to the total mass of the ionomer solution was adjusted so as to be 7.5% by mass, and the alcohol ratio in the solvent was adjusted so as to be 85%. Shearing treatment was performed by agitating the adjusted ionomer solution for 60 minutes at a rotation speed of 4000 rpm with a disper (disperser). The liquid mixture obtained in this way was set as the ink of Example 1. The concentration of solid content was determined by calculating the proportion of the total mass of ionomer relative to the total mass of the prepared ink. Then, the concentration of solid content was measured using a moisture meter (MOC63u, manufactured by Shimadzu Corp.) for confirmation.

### Examples 2 to 6

Examples 2 to 6 prepared inks by the same method as Example 1, except for adjusting the concentration of solid content to different values from Example 1. The concentration of solid content was adjusted to 8% by mass in Example 2, 8.5% by mass in Example 3, 9% by mass in Example 4, 9.5% by mass in Example 5, and 10% by mass in Example 6.

### Comparative Examples 1 to 7

Comparative Examples 1 to 7 prepared inks by the same method as Example 1, except for adjusting the concentration of solid content and the alcohol ratio in the solvent to different values from Example 1. The alcohol ratio in the solvent was adjusted to 65% by mass in Comparative Examples 1 to 7. The concentration of solid content was adjusted to 7% by mass in Comparative Example 1, 7.5% by mass in Comparative Example 2, 8% by mass in Comparative Example 3, 8.5% by mass in Comparative Example 4, 9% by mass in Comparative Example 5, 9.5% by mass in Comparative Example 6, and 10% by mass in Comparative Example 7.

### Comparative Examples 8 to 14

Comparative Examples 8 to 14 prepared inks by the same method as Example 1, except for adjusting the concentration of solid content and the alcohol ratio in the solvent to different values from Example 1. The alcohol ratio in the solvent was adjusted to 70% by mass in Comparative Examples 8 to 14. The concentration of solid content was adjusted to 7% by mass in Comparative Example 8, 7.5% by mass in Comparative Example 9, 8% by mass in Comparative Example 10, 8.5% by mass in Comparative Example 11, 9% by mass in Comparative Example 12, 9.5% by mass in Comparative Example 13, and 10% by mass in Comparative Example 14.

### Comparative Examples 15 to 21

Comparative Examples 15 to 21 prepared inks by the same method as Example 1, except for adjusting the concentration of solid content and the alcohol ratio in the solvent to different values from Example 1. The alcohol ratio in the solvent was adjusted to 75% by mass in Comparative Examples 15 to 21. The concentration of solid content was adjusted to 7% by mass in Comparative Example 15, 7.5% by mass in Comparative Example 16, 8% by mass in Comparative Example 17, 8.5% by mass in Comparative Example 18, 9% by mass in Comparative Example 19, 9.5% by mass in Comparative Example 20, and 10% by mass in Comparative Example 21.

### Comparative Examples 22 to 28

Comparative Examples 22 to 28 prepared inks by the same method as Example 1, except for adjusting the concentration of solid content and the alcohol ratio in the solvent to different values from Example 1. The alcohol ratio in the solvent was adjusted to 80% by mass in Comparative Examples 22 to 28. The concentration of solid content was adjusted to 7% by mass in Comparative Example 22, 7.5% by mass in Comparative Example 23, 8% by mass in Comparative Example 24, 8.5% by mass in Comparative Example 25, 9% by mass in Comparative Example 26, 9.5% by mass in Comparative Example 27, and 10% by mass in Comparative Example 28.

### Comparative Example 29

Comparative Example 29 prepared an ink by the same method as Example 1, except for adjusting the concentration of solid content to 7%.

### <Thickening Evaluation Test>

A thickening evaluation test to evaluate the presence/absence of thickening was performed on the inks of Examples 1 to 6 and Comparative Examples 1 to 29. The thickening evaluation test was performed by measuring the viscosity of the ink immediately after agitating the ionomer solution generated in the generation step S11 for 60 minutes at a rotation speed of 4000 rpm with a disper. The viscosity of each ink was measured by a cone plate viscometer (rheometer).

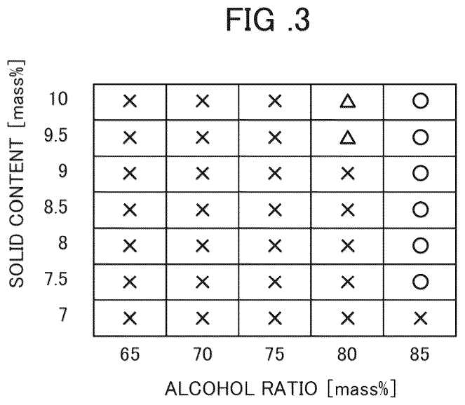

FIG. 3 is a graph showing the evaluation results of thickening, i.e. the relationships of the concentration of the solid content in the ink and alcohol ratio in the solvent with the viscosity of the ink, for Examples 1 to 6 and Comparative Examples 1 to 29. In the thickening evaluation results, a case of no change being observed compared to before shear application is designated as “x”, a case of a temporary rise in viscosity being observed but immediately returning to the viscosity prior to shear application is designated as “A”, and a case of a rapid rise in viscosity (gelation) being observed, and the fluidity being remarkably lost is designed as “O”. As shown in FIG. 3, in order to establish the ink in gel form, it could be confirmed as necessary to set the concentration of solid content in the ink as 7.5% by mass or more, and set the alcohol ratio in the solvent as 85% or more.

### <Confirmation Test of Shear Velocity Required in Gelation>

The relationship of the conditions of shearing treatment during production of the ink and the shearing velocity required to establish in gel form again the ink which has returned to liquid form after production was confirmed. The sample of ink used in the present test was prepared by the same method as the ink of Example 1, except for the composition. The composition of the sample was a concentration of solid content of 8.33% by mass, alcohol ratio in the solvent of 85% by mass, and concentration of 1-propanol in the alcohol of 74.87%. Then, 10 types of samples with different agitation conditions (agitation time) in the shearing treatment during production of the ink were prepared. The agitation time in the shearing treatment of the 10 types of samples were set to 0 minutes, 10 minutes, 20 minutes, 24 minutes, 40 minutes, 50 minutes, 60 minutes, 70 minutes and 87 minutes, respectively. The agitation speed was set to a rotation speed of 4000 rpm by the disper (disperser). The viscosity was confirmed in the case of performing shearing treatment at each shear velocity was confirmed for each sample left to stand for a predetermined time after preparation, and returning from gel form to liquid form.

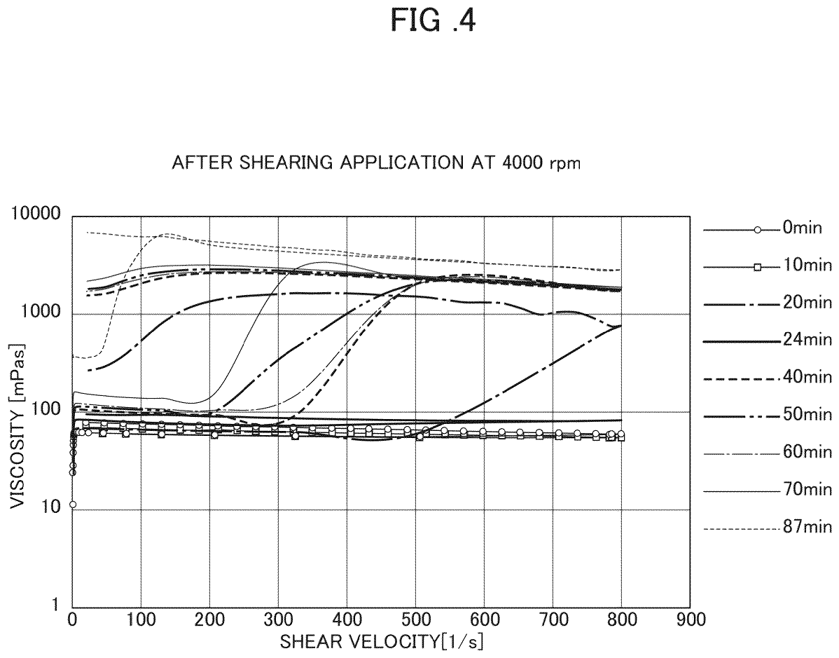

FIG. 4 is a graph showing relationships of shear velocity of the shear force applied to the 10 types of samples and the viscosity of each sample. As shown in FIG. 4, it could be confirmed possible to establish the ink in gel form, by agitating for 20 minutes or longer at a rotation speed of 4000 rpm of the dispersing impeller, in the shearing treatment during production of the ink. In addition, it could be confirmed that gelation was possible by a lower shear velocity with a longer agitation time in the shearing treatment during production of the ink. From these results, it could be confirmed that the ease of gelation of the ink could be adjusted after production by adjusting the agitation time in the shearing treatment step S12. For example, in the case of coating using a slot die, since the shearing strength acting on the ink changes according to the slot width of the slot die, it is possible to adjust the agitation time in the shearing treatment in accordance with the slot die using in coating.

### EXPLANATION OF REFERENCE NUMERALS

1 fuel cell
2 membrane electrode assembly
3 diffusion layer
21 electrolyte member
22 catalyst layer

What is claimed is:

1. An ink for use in formation of a membrane electrode assembly of a fuel cell, the ink comprising:
an ionomer; and a solvent having an alcohol ratio in solvent of 85% by mass or more,
wherein the ink has a concentration of a solid content of 7.5% by mass or more.

2. The ink according to claim 1, wherein 74% by mass or more of the alcohol contained in the solvent is 1-propanol.

3. The ink according to claim 1, wherein a solubility parameter of the solvent is 13 to 15.

4. The ink according to claim 2, wherein a solubility parameter of the solvent is 13 to 15.

5. A method for producing an ink for use in formation of a membrane electrode assembly of a fuel cell, the method comprising:
a generation step of mixing an ionomer and a solvent to generate an ionomer solution having a concentration of solid content of 7.5% by mass or more, and having an alcohol ratio in the solvent of 85% by mass or more; and
a shearing treatment step of applying a shear force to the ionomer solution generated in the generation step.

6. The method for producing an ink according to claim 4, wherein 74% by mass or more of alcohol contained in the solvent is 1-propanol.

7. The method for producing an ink according to claim 5, wherein a solubility parameter of the solvent is adjusted to 13 to 15 in the generation step.

8. The method for producing an ink according to claim 6, wherein a solubility parameter of the solvent is adjusted to 13 to 15 in the generation step.
